(19) United States
(12) Patent Application Publication
(10) Pub. No.: US 2021/0239382 A1
(43) Pub. Date: Aug. 5, 2021

(54) REFRIGERATOR

(71) Applicant: Samsung Electronics Co., Ltd., Suwon-si (KR)

(72) Inventors: Dongnyeol RYU, Suwon-si (KR); Jongeun KIM, Suwon-si (KR); Sungsoo SHIN, Suwon-si (KR); Kihak HONG, Suwon-si (KR); Hyunho HA, Suwon-si (KR)

(73) Assignee: Samsung Electronics Co., Ltd., Suwon-si (KR)

(21) Appl. No.: 17/165,170

(22) Filed: Feb. 2, 2021

(30) Foreign Application Priority Data
Feb. 4, 2020 (KR) 10-2020-0012900

(51) Int. Cl. F25D 11/02; F25D 17/06

(52) U.S. Cl. CPC F25D 11/022; F25D 2317/063; F25D 17/065

(57) ABSTRACT

Disclosed herein is a refrigerator. The refrigerator includes a body, a storage compartment provided to allow a front surface thereof to be open in the body and including a freezing compartment and a refrigerating compartment, a freezing compartment evaporator provided at a rear of the freezing compartment and configured to generate cold air supplied to the freezing compartment and the refrigerating compartment, a fan including a first fan configured to guide cold air generated by the freezing compartment evaporator to the freezing compartment, and a second fan configured to guide the cold air generated by the freezing compartment evaporator to the refrigerating compartment, and a variable temperature compartment formed by a roll-bond evaporator disposed inside the refrigerating compartment.

### CROSS-REFERENCE TO RELATED APPLICATION(S)

This application is based on and claims priority under 35 U.S.C. § 119 to Korean Patent Application No. 10-2020-0012900, filed on Feb. 4, 2020, in the Korean Intellectual Property Office, the disclosure of which is incorporated by reference herein in its entirety.

### BACKGROUND

### 1. Field

The disclosure relates to a refrigerator configured to separately cool a variable temperature compartment provided in a refrigerating compartment using a roll-bond evaporator.

### 2. Description of the Related Art

A refrigerator is a home appliance that keeps food fresh by including a body including a storage compartment, a cold air supply device configured to supply cold air to the storage compartment, and a door configured to open and close the storage compartment.

The storage compartment includes a refrigerating compartment and a freezing compartment, and a variable temperature compartment may be provided inside the refrigerating compartment. The refrigerating compartment, the freezing compartment, and the variable temperature compartment maintain their temperature by receiving cold air generated from an evaporator.

In general, the refrigerating compartment and the freezing compartment maintain their temperature by respectively receiving cold air generated by separate evaporators or by receiving cold air generated by one evaporator.

When the refrigerating compartment and the freezing compartment are supplied with cold air by one evaporator, the evaporator is provided as a freezing compartment evaporator disposed at the rear of the freezing compartment. A portion of the cold air generated from the freezing compartment evaporator is supplied to the freezing compartment by a freezing compartment fan. At this time, because cold air is required to be supplied to the variable temperature compartment provided inside the refrigerating compartment, the refrigerating compartment does not receive cold air by a refrigerating compartment fan but the refrigerating compartment receives cold air by a damper together with the variable temperature compartment. That is, a portion of the cold air generated by the freezing compartment evaporator is guided to a refrigerating compartment damper by the freezing compartment fan, and then is supplied to the refrigerating compartment by the refrigerating compartment damper. In addition, a portion of the cold air generated by the freezing compartment evaporator is guided to a variable temperature compartment damper by the freezing compartment fan, and then supplied to the variable temperature compartment by the variable temperature compartment damper.

Because the cold air generated from the freezing evaporator is supplied to the freezing compartment, the refrigerating compartment, and the variable temperature compartment by the freezing compartment fan, it is difficult to adjust the number of revolutions of the freezing compartment fan and thus it is difficult to convert the freezing compartment into the refrigerating compartment and to use the freezing compartment as the refrigerating compartment.

In addition, because the variable temperature compartment is cooled by the cold air generated by the freezing compartment evaporator, the variable temperature compartment requires a separate thermal insulation structure, and the material cost may increase. In addition, because an internal space of the variable temperature compartment is reduced due to the thermal insulation structure, a space for storing food in the variable temperature compartment may be reduced. In addition, because the freezing compartment evaporator is required to be operated to the maximum value in order to cool the variable temperature compartment, power consumption may increase.

### SUMMARY

Therefore, it is an aspect of the disclosure to provide a refrigerator capable of convert a freezing compartment into a refrigerating compartment so as to use the freezing compartment as the refrigerating compartment by allowing a variable temperature compartment to be separately cooled by a roll-bond evaporator and by allowing cold air, which is generated by a freezing compartment evaporator, to be supplied to the freezing compartment and the refrigerating compartment through a freezing compartment fan and a refrigerating compartment fan.

Additional aspects of the disclosure will be set forth in part in the description which follows and, in part, will be obvious from the description, or may be learned by practice of the disclosure.

In accordance with an aspect of the disclosure, a refrigerator includes a body, a storage compartment provided to allow a front surface thereof to be open in the body and including a freezing compartment and a refrigerating compartment, a freezing compartment evaporator provided at a rear of the freezing compartment and configured to generate cold air supplied to the freezing compartment and the refrigerating compartment, a fan including a first fan configured to guide cold air generated by the freezing compartment evaporator to the freezing compartment, and a second fan configured to guide the cold air generated by the freezing compartment evaporator to the refrigerating compartment, and a variable temperature compartment formed by a roll-bond evaporator disposed inside the refrigerating compartment.

The refrigerator may further include a water collecting tray disposed below the variable temperature compartment and provided to collect defrost water that is generated and dropped from the roll-bond evaporator.

The variable temperature compartment may be formed in a position close to the freezing compartment in the refrigerating compartment.

The refrigerator may further include a freezing compartment cold air duct disposed in front of the freezing compartment evaporator and provided to discharge cold air, which is generated by the freezing compartment evaporator, to the freezing compartment, a refrigerating compartment cold air duct disposed at a rear side of the refrigerating compartment and provided to discharge the cold air, which is guided from the freezing compartment cold air duct, to the refrigerating compartment, and a connection duct provided to connect the freezing compartment cold air duct to the refrigerating compartment cold air duct.

The freezing compartment cold air duct may include a first cold air duct disposed in front of the freezing compartment evaporator and provided with a fan mounting portion to which the fan is mounted, and a second cold air duct disposed in front of the first cold air duct and provided to form a first flow path between the first cold air duct and the second cold air duct, the first flow path provided to allow cold air, which is generated by the freezing compartment evaporator, to be guided to the freezing compartment by the first fan.

The fan mounting portion may include a first fan mounting portion to which the first fan is mounted, and a second fan mounting portion to which the second fan is mounted.

The first cold air duct may include a refrigerating compartment guide duct provided to form a portion of a second flow path provided to allow the cold air, which is generated by the freezing compartment evaporator, to be guided to the refrigerating compartment by the second fan; a first guide portion provided to form a remaining portion of the second flow path by being connected to the refrigerating compartment guide duct, and a cold air discharge portion provided to connect the first guide portion to the connection duct so as to allow the cold air of the second flow path to be discharged to the connection duct.

The second cold air duct may include a plurality of freezing compartment discharge holes provided to discharge the cold air of the first flow path to the freezing compartment, and a second guide portion provided to form a remaining portion of the second flow path together with the first guide portion.

Because a temperature of the variable temperature compartment is adjusted according to an amount of cold air supplied from the roll-bond evaporator, a temperature of the freezing compartment may be adjusted to be maintained at the same temperature as a temperature of the refrigerating compartment by adjusting the number of revolutions of the first fan to reduce an amount of cold air supplied to the freezing compartment.

The temperature of the variable temperature compartment may be adjusted to be maintained at the same temperature as a temperature of the freezing compartment or the refrigerating compartment according to an amount of cold air supplied from the roll-bond evaporator.

When the temperature of the freezing compartment is referred to as a first temperature and the temperature of the refrigerating compartment is referred to as a second temperature, the refrigerating compartment may maintain the second temperature by allowing an amount of cold air, which is generated by the freezing compartment evaporator and then guided by the second fan, to be constant.

In response to that the first fan is rotated and an amount of cold air generated by the roll-bond evaporator is maximized to allow the freezing compartment to maintain the first temperature, the variable temperature compartment may maintain the first temperature.

In response to that the first fan is rotated and an operation of the roll-bond evaporator is stopped to allow the freezing compartment to maintain the first temperature, the variable temperature compartment may maintain the second temperature by the cold air of the inside of the refrigerating compartment.

In response to that the amount of cold air guided by the first fan is reduced by reducing the number of revolutions of the first fan, and the amount of cold air generated by the roll-bond evaporator is maximized, the freezing compartment may maintain the second temperature, and the variable temperature compartment may maintain the first temperature.

In response to that the amount of cold air guided by the first fan is reduced by reducing the number of revolutions of the first fan, and the operation of the roll-bond evaporator is stopped, the freezing compartment may maintain the second temperature, and the variable temperature compartment may maintain the second temperature by the cold air of the inside of the refrigerating compartment.

In accordance with another aspect of the disclosure, a refrigerator includes a body, a storage compartment provided to allow a front surface thereof to be open in the body and including a freezing compartment and a refrigerating compartment, a freezing compartment evaporator configured to generate cold air supplied to the freezing compartment and the refrigerating compartment, a fan including a first fan configured to guide cold air generated by the freezing compartment evaporator to the freezing compartment, and a second fan configured to guide the cold air generated by the freezing compartment evaporator to the refrigerating compartment, and a variable temperature compartment formed by a roll-bond evaporator disposed inside the refrigerating compartment and configured to allow a temperature thereof to be adjusted according to an amount of cold air supplied from the roll-bond evaporator. A temperature of the freezing compartment is adjusted to be maintained at the same temperature as a temperature of the refrigerating compartment by reducing the number of revolutions of the first fan to reduce an amount of cold air guided by the first fan.

In response to that an amount of cold air supplied from the roll-bond evaporator is maximized in a state in which the temperature of the refrigerating compartment is kept constant, the variable temperature compartment may maintain a temperature thereof that is the same as a temperature of the freezing compartment.

In response to that an operation of the roll-bond evaporator is stopped in a state in which the temperature of the refrigerating compartment is kept constant, the variable temperature compartment may maintain a temperature thereof that is the same as a temperature of the refrigerating compartment by an internal temperature of the refrigerating compartment.

The variable temperature compartment may be affected by an internal temperature of the refrigerating compartment and the variable temperature compartment may be separately cooled by the roll-bond evaporator and thus the variable temperature compartment may be adjusted to maintain a temperature thereof that is the same as a temperature of the refrigerating compartment or that is lower than a temperature of the refrigerating compartment.

The variable temperature compartment may be formed in a position close to the freezing compartment in the refrigerating compartment, and a water collecting tray may be disposed below the variable temperature compartment and provided to collect defrost water that is generated and dropped from the roll-bond evaporator.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view illustrating a refrigerator according to an embodiment of the disclosure;

FIG. 2 is a perspective view illustrating a roll-bond evaporator according to an embodiment of the disclosure;

FIG. 3 is a side cross-sectional view of the refrigerator according to an embodiment of the disclosure;

FIG. 4 is an exploded perspective view of a freezing compartment cold air duct according to an embodiment of the disclosure;

FIG. 5 is a view illustrating FIG. 4 from a different direction;

FIG. 6 is a view illustrating a flow of a refrigerant according to an embodiment of the disclosure; and

FIG. 7 is a view illustrating a state in which cold air generated by a freezing compartment evaporator is discharged to the freezing compartment and a refrigerating compartment according to an embodiment of the disclosure.

### DETAILED DESCRIPTION

Embodiments described in the disclosure and configurations shown in the drawings are merely examples of the embodiments of the disclosure, and may be modified in various different ways at the time of filing of the present application to replace the embodiments and drawings of the disclosure.

In addition, the same reference numerals or signs shown in the drawings of the disclosure indicate elements or components performing substantially the same function.

Also, the terms used herein are used to describe the embodiments and are not intended to limit and/or restrict the disclosure. The singular forms “a,” “an” and “the” are intended to include the plural forms as well, unless the context clearly indicates otherwise. In this disclosure, the terms “including”, “having”, and the like are used to specify features, numbers, steps, operations, elements, components, or combinations thereof, but do not preclude the presence or addition of one or more of the features, elements, steps, operations, elements, components, or combinations thereof.

It will be understood that, although the terms first, second, third, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

In the following detailed description, the terms of “front end”, “rear end”, “upper portion”, “lower portion”, “upper end”, “lower end” and the like may be defined by the drawings, but the shape and the location of the component is not limited by the term.

The disclosure will be described more fully hereinafter with reference to the accompanying drawings

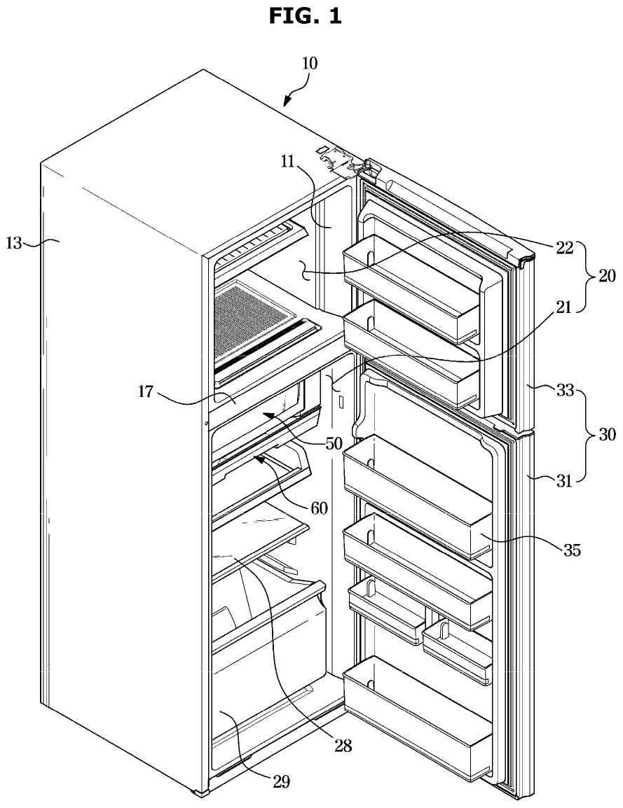

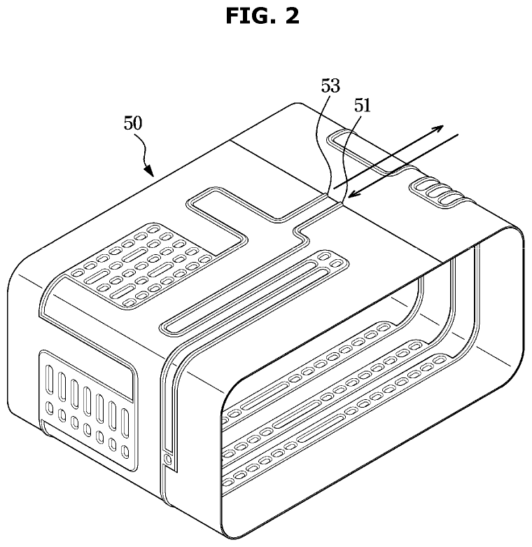

FIG. 1 is a perspective view illustrating a refrigerator according to an embodiment of the disclosure. FIG. 2 is a perspective view illustrating a roll-bond evaporator according to an embodiment of the disclosure.

As illustrated in FIGS. 1 and 2, a refrigerator may include a body 10, storage compartments 20 provided in plural in the body 10 to allow a front surface thereof to be open, and a door 30 configured to open and close the open front surface of the storage compartment 20.

The body 10 may include an inner case 11 provided to form the storage compartment 20 and an outer case 12 provided to form an appearance thereof. Between the inner case 11 and the outer case 12, an insulating material may be foamed to prevent leakage of the cold air of the storage compartment 20.

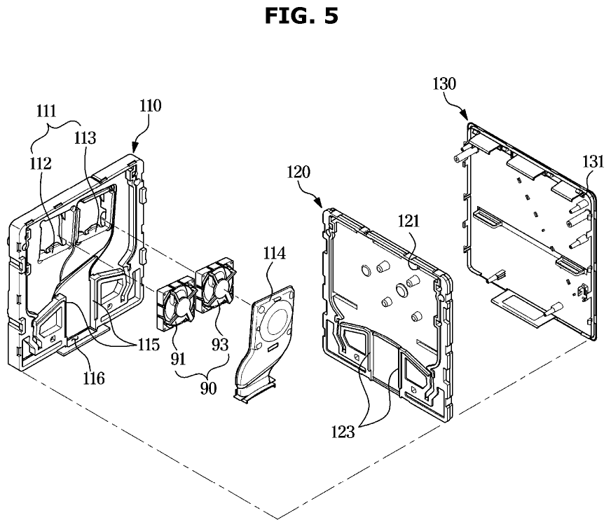

A machine room 24, in which a compressor 25 configured to compress a refrigerant and a condenser 26 configured to condense the refrigerant compressed by the compressor 25 are installed, may be provided at the rear and lower side of the body 10 (refer to FIG. 5).

The storage compartment 20 may be divided into a refrigerating compartment 21 that is a lower storage compartment and a freezing compartment 22 that is an upper storage compartment by a partition wall 17. In the storage compartment 20, a plurality of shelves 28 on which foods are stacked and stored may be provided. Further, a storage container 29 provided to store food may be provided inside the storage compartment 20. In the refrigerating compartment 21, a variable temperature compartment 23 may be provided. The variable temperature compartment 23 may be formed by a roll-bond evaporator 50. A description thereof will be described.

The refrigerating compartment 21 and the freezing compartment 22 may be opened and closed by a refrigerating compartment door 31 and a freezing compartment door 33 which are rotatably coupled to the body 10, respectively. On a rear surface of the door 30, a door guard 35 in which food is stored may be provided in plural.

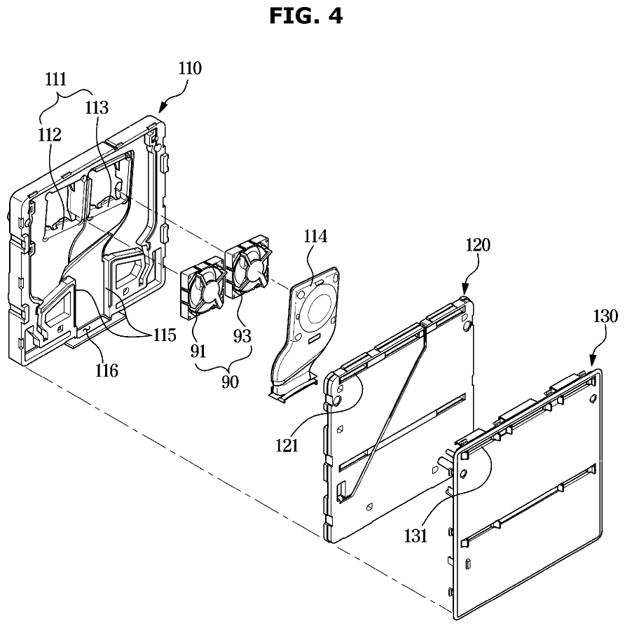

The refrigerator may include a cold air supply device configured to supply cold air to the storage compartment 20. The cold air supply device may include the compressor 25 installed in the machine room 24 to compress the refrigerant, the condenser 26 installed in the machine room 24 to condense the compressed refrigerant, an expansion valve 27 configured to expand the refrigerant condensed by the condenser 26, a freezing compartment evaporator 40 installed at a rear of the storage compartment 20 to generate cold air, a fan 90 configured to guide cold air, which is generated by the freezing compartment evaporator 40, to be supplied to the storage compartment 20, and a cold air duct 70 and 100 configured to guide and discharge the cold air, which is guided by the fan 90, to the storage compartment 20 (refer to FIGS. 2 and 4).

The variable temperature compartment 23 may be formed by the roll-bond evaporator 50 provided in the refrigerating compartment 21. It may be appropriate that the variable temperature compartment 23 is disposed in the refrigerating compartment 21 to be at a position closest to the freezing compartment 22. The roll-bond evaporator 50 may be provided with a four-sided evaporator including an upper surface, a lower surface, a left surface and a right surface which are formed in a flat plate shape. The roll-bond evaporator 50 may be a plate cooler formed in such a way that a refrigerant tube, through which a refrigerant flows, is provided in an aluminum plate. The roll-bond evaporator 50 may include a refrigerant inlet 51 through which a refrigerant is introduced and a refrigerant outlet 53 through which the refrigerant is discharged. The roll-bond evaporator 50 may directly generate cold air to cool the variable temperature compartment 23 corresponding to an internal space of the roll-bond evaporator 50. The variable temperature compartment 23 does not include a separate thermal insulation structure, and thus in a state of maintaining the variable temperature compartment 20 at the same temperature as a temperature of the refrigerating compartment 21, it is possible to maintain the variable temperature compartment 23 at the same temperature as the temperature of the refrigerating compartment 21 by the cold air, which is supplied to the inside of the refrigerating compartment 21, without an operation of the roll-bond evaporator 50. Further, in order to maintain the variable temperature compartment 23 at a temperature less than the temperature of the refrigerating compartment 21, it is possible to supply the cold air to the variable temperature compartment 23 by operating the roll-bond evaporator 50. According to an operating rate of the roll-bond evaporator 50, the variable temperature compartment 23 may adjust a temperature thereof from the same temperature as the refrigerating compartment 21 to the same temperature as the freezing compartment 22.

Because the variable temperature compartment 23 is cooled by the cold air generated from the roll-bond evaporator 50 without directly receiving the cold air generated from the freezing compartment evaporator 40, the variable temperature compartment 23 may not need a separate thermal insulation structure. Because the separate thermal insulation structure is not required, the material cost may be saved. In addition, because the thermal insulation structure is not required, a space, in which food is stored, may be increased in the variable temperature compartment 23. In addition, because temperature control of the variable temperature compartment 23 is performed by the operation of the roll-bond evaporator 50, it is possible to prevent an increase in power consumption caused by cooling the variable temperature compartment 23.

A water collecting tray 60 may be provided under the variable temperature compartment 23. The water collecting tray 60 may be provided under the roll-bond evaporator 50, which forms the variable temperature compartment 23, to collect defrost water that is generated and dropped from the roll-bond evaporator 50. The roll-bond evaporator 50 provided to form the variable temperature compartment 23 is exposed to the refrigerating compartment 21, and thus frost may be generated. Because the separate thermal insulation structure is not applied to the variable temperature compartment 23, it is difficult to prevent the frost generated in the roll-bond evaporator 50. Accordingly, when the frost is melted, it may fall to a lower portion of the variable temperature compartment 23. Therefore, the defrost water generated and dropped from the roll-bond evaporator 50 may be dropped to the water collecting tray 60 and collected.

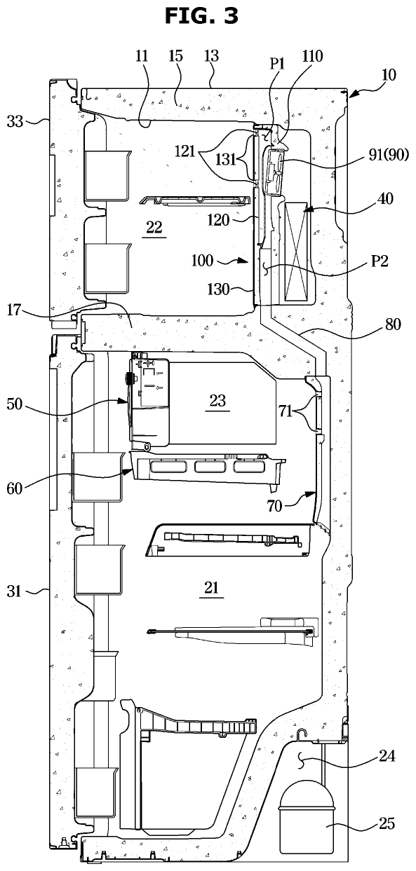

FIG. 3 is a side cross-sectional view of the refrigerator according to an embodiment of the disclosure. FIG. 4 is an exploded perspective view of a freezing compartment cold air duct according to an embodiment of the disclosure. FIG. 5 is a view illustrating FIG. 4 from a different direction.

As illustrated in FIGS. 3 to 5, the cold air ducts 70 and 100 may be provided at the rear side of the storage compartment 20 to supply the cold air, which is generated from the freezing compartment evaporator 40, to the refrigerating compartment 21 and the freezing compartment 22.

The drawing illustrates a top mounted freezer (TMF) type-refrigerator in which the refrigerating compartment 21 is located at the bottom and the freezing compartment 22 is located at the top, but is not limited thereto. That is, the refrigerator may be a bottom mounted freezer (BMF) type-refrigerator in which the refrigerating compartment 21 is located at the top and the freezing compartment 22 is located at the bottom. In this case, the variable temperature compartment 23 may be disposed in a lower portion of the refrigerating compartment 21 to be closest to the freezing compartment 22. In addition, the refrigerator may be a side by side (SBS) type refrigerator, in which the refrigerating compartment 21 and the freezing compartment 22 are disposed left and right sides. In this case, the variable temperature compartment 23 may be close to the freezing compartment 22 regardless of a position, and thus the variable temperature compartment 23 may be located at any position inside the refrigerating compartment 21. In addition to the above refrigerators, the variable temperature compartment 23 may be applied equally to other types of refrigerators. That is, even in the case of other types of refrigerators, the variable temperature compartment 23 may be disposed in the refrigerating compartment 21 and may be disposed in a position close to the freezing compartment 22 in the refrigerating compartment 21.

The cold air ducts 70 and 100 may include a refrigerating compartment cold air duct 70 disposed at the rear side of the refrigerating compartment 21 and a freezing compartment cold air duct 100 disposed at the rear side of the freezing compartment 22.

The refrigerating compartment cold air duct 70 may be disposed at the rear side of the refrigerating compartment 21. The refrigerating compartment cold air duct 70 may be connected to the freezing compartment cold air duct 100 through a connection duct 80. The refrigerating compartment cold air duct 70 may include a plurality of refrigerating compartment discharge holes 71 provided to discharge cold air to the refrigerating compartment 21. A portion of the cold air generated by the freezing compartment evaporator 40 may be guided to the freezing compartment cold air duct 100 by a first fan 91, which is described below, and discharged to the freezing compartment 22. A remaining portion of the cold air generated by the freezing compartment evaporator 40 may be guided from the freezing compartment cold air duct 100 to the refrigerating compartment cold air duct 70 by a second fan 93 to be described below. The cold air guided to the refrigerating compartment cold air duct 70 may be discharged to the refrigerating compartment 21.

The freezing compartment cold air duct 100 may be disposed at the rear side of the freezing compartment 22. The freezing compartment cold air duct 100 may be provided in front of the freezing compartment evaporator 40. The freezing compartment cold air duct 100 may be connected to the freezing compartment cold air duct 70 through the connection duct 80.

The freezing compartment cold air duct 100 may include a first cold air duct 110 disposed in front of the freezing compartment evaporator 40, a second cold air duct 120 disposed in front of the first cold air duct 110, and a cold air duct cover 130 disposed in front of the second cold air duct 120. A first flow path P1 provided to guide the cold air, which is generated by the freezing compartment evaporator 40, to the freezing compartment 22 by the first fan 91 may be formed between the first cold air duct 110 and the second cold air duct 120.

The first cold air duct 110 may include a fan mounting portion 111 on which the fan 90 is mounted, a refrigerating compartment guide duct 114 provided to form a portion of a second flow path P2 provided to allow the cold air, which is generated by the freezing compartment evaporator 40, to be guided to the refrigerating compartment 21 by the second fan 93, a first guide portion 115 provided to form a remaining portion of the second flow path P2 by being connected to the refrigerating compartment guide duct 114, and a cold air discharge portion 116 provided to connect the first guide portion 115 to the connection duct 80 so as to allow the cold air of the second flow path P2 to be discharged to the connection duct 80.

The fan mounting portion 111 may include a first fan mounting portion 112 to which the first fan 91 is mounted, and a second fan mounting portion 113 to which the second fan 93 is mounted. The first fan 91 may guide the cold air generated by the freezing compartment evaporator 40 to the first flow path P1. The second fan 93 may guide the cold air generated by the freezing compartment evaporator 40 to the second flow path P2.

The refrigerating compartment guide duct 114 may form a portion of the second flow path P2 provided to guide the cold air generated by the freezing compartment evaporator 40 to the refrigerating compartment cold air duct 70. The cold air generated in the freezing compartment evaporator 40 may be guided to the refrigerating compartment guide duct 114 by the second fan 93.

The first guide portion 115 may be provided in a lower portion of the first cold air duct 110 to be connected to the refrigerating compartment guide duct 114. The first guide portion 115 may be provided in a pair. The first guide portion 115 may be formed to protrude from the front surface of the first cold air duct 110 to the front side. The first guide portion 115 may form the remaining portion of the second flow path P2 together with a second guide portion 123 of the second cold air duct 120 to be described below.

The cold air discharge portion 116 may be provided under the first guide portion 115. The cold air discharge portion 116 may connect the first guide portion 115 to the connection duct 80 so as to allow the cold air of the second flow path P2 to be discharged to the connection duct 80.

The second cold air duct 120 may include a plurality of first freezing compartment discharge holes 121 provided to discharge the cold air of the first flow path P1 to the freezing compartment 22, and the second guide portion 123 provided to form the remaining portion of the second flow path P2 together with the first guide portion 115 of the first cold air duct 110.

The plurality of first freezing compartment discharge holes 121 may discharge the cold air, which is guided to the first flow path P1 by the first fan 91, to the freezing compartment 22. The plurality of first freezing compartment discharge holes 121 may be formed at positions corresponding to a plurality of second freezing compartment discharge holes 131 formed in the cold air duct cover 130. The cold air guided to the first flow path P1 by the first fan 91 may be discharged to the freezing compartment 22 through the plurality of first freezing compartment discharge holes 121 and the plurality of second freezing compartment discharge holes 131.

The second guide portion 123 may be provided in a lower portion of the second cold air duct 120 to be connected to the refrigerating compartment guide duct 114 of the first cold air duct 110. The second guide portion 123 may be provided in a pair. The second guide portion 123 may be formed to protrude from the rear surface of the second cold air duct 120 to the rear side. The second guide portion 123 may form the remaining portion of the second flow path P2 together with the first guide portion 115 of the first cold air duct 110. That is, the second flow path P2 may be formed by the refrigerating compartment guide duct 114, the first guide portion 115 and the second guide portion 123.

The cold air duct cover 130 may be disposed in front of the second cold air duct 120. The cold air duct cover 130 may include the plurality of second freezing compartment discharge holes 131. The plurality of second freezing compartment discharge holes 131 may be provided at positions corresponding to the plurality of first freezing compartment discharge holes 121 of the second cold air duct 120. Accordingly, the cold air, which is generated from the freezing compartment evaporator 40 and guided to the first flow path P1 by the first fan 91, may be discharged to the inside of the freezing compartment 22 through the plurality of first freezing discharge holes 121 and the plurality of second freezing discharge holes 131.

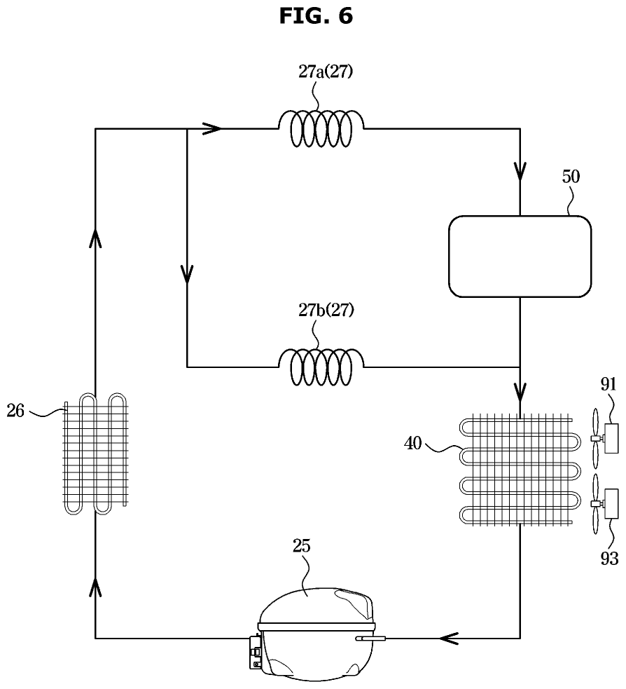

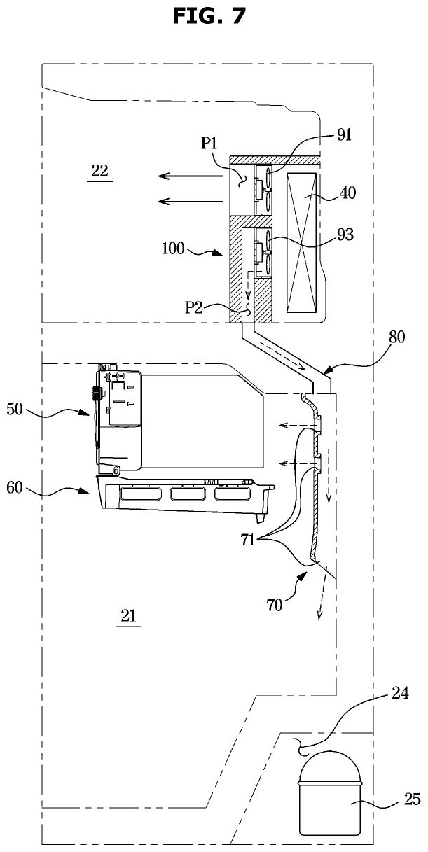

FIG. 6 is a view illustrating a flow of a refrigerant according to an embodiment of the disclosure. FIG. 7 is a view illustrating a state in which cold air generated by a freezing compartment evaporator is discharged to the freezing compartment and a refrigerating compartment according to an embodiment of the disclosure.

As illustrated in FIGS. 6 and 7, a gaseous refrigerant may be compressed into a high-temperature and high-pressure gaseous refrigerant by the compressor 25. The high-temperature and high-pressure gaseous refrigerant in the compressor 25 may be transferred to the condenser 26. The high-temperature and high-pressure gaseous refrigerant may release heat in the condenser 26 and then be liquefied. A low-temperature and high-pressure liquid refrigerant that is generated by being condensed and being liquefied in the condenser 26 may be transferred to the expansion valve 27. The low-temperature and high-pressure liquid refrigerant may be expanded into a low-temperature and low-pressure liquid refrigerant in the expansion valve 27.

The expansion valve 27 may include a first expansion valve 27a and a second expansion valve 27b. A portion of the low-temperature and high-pressure liquid refrigerant condensed in the condenser 26 may be transferred to the first expansion valve 27a and expanded into a low temperature and low-pressure liquid refrigerant, and then transferred to the roll-bond evaporator 50 provided to form the variable temperature compartment 23. The low-temperature and low-pressure liquid refrigerant transferred to the roll-bond evaporator 50 may absorb heat while evaporating, thereby generating cold air. The variable temperature compartment 23 may be cooled by cold air generated from the roll-bond evaporator 50 and supplied to the variable temperature compartment 23.

A remaining portion of the low-temperature and high-pressure liquid refrigerant condensed in the condenser 26 may be transferred to the second expansion valve 27b and then expanded into a low temperature and low-pressure liquid refrigerant, and then transferred to the freezing compartment evaporator 40. The low-temperature and low-pressure liquid refrigerant transferred to the freezing compartment evaporator 40 may absorb heat while evaporating, thereby generating cold air. The refrigerating compartment 21 and the freezing compartment 22 may be cooled by cold air generated from the freezing compartment evaporator 40.

Because the variable temperature compartment 23 is cooled by the cold air supplied from the roll-bond evaporator 50, the temperature of the freezing compartment 22 may be adjusted to be maintained at the same temperature as a temperature of the refrigerating compartment 21 by reducing an amount of cold air that is generated in the freezing compartment evaporator 40 and supplied to the freezing compartment 22. That is, because a portion of the cold air generated by the freezing evaporator 40 is guided to the first flow path P1 by the first fan 91 and then supplied to the freezing compartment 22, the temperature of the freezing compartment 22 may be maintained at the same temperature as a temperature of the refrigerating compartment 21 by reducing the number of revolutions of the first fan 91. Accordingly, the freezing compartment 22 may be used as the refrigerating compartment 21. The freezing compartment 22 may be converted into the refrigerating compartment 21 and thus a user can further vary the types of foods that can be stored in the refrigerator.

A temperature of the variable temperature compartment 23 may be adjusted according to an amount of cold air supplied from the roll-bond evaporator 50 so as to be maintained at the same temperature as a temperature of the freezing compartment 22 or at the same temperature as a temperature of the refrigerating compartment 21. Alternatively, the temperature of the variable temperature compartment 23 may be adjusted to be maintained at a temperature between the temperature of the refrigerating compartment 21 and the temperature of the freezing compartment 22.

The refrigerating compartment 21 may be cooled by cold air that is generated by the freezing compartment evaporator 40 and guided by the second fan 93. In this case, in order to allow the refrigerating compartment 21 to be maintained at the temperature of the refrigerating compartment 21, the second fan 93 may maintain a constant number of revolutions to allow the amount of cold air supplied to the refrigerating compartment 21 to be constant.

When the temperature of the freezing compartment 22 is referred to as a first temperature and the temperature of the refrigerating compartment 21 is referred to as a second temperature, in response to that the first fan 91 is rotated and the amount of cold air generated by the roll-bond evaporator 50 is maximized to allow the freezing compartment 22 to maintain the first temperature, the freezing compartment 22 may maintain the first temperature and the variable temperature compartment 23 may maintain the first temperature due to the maximum amount of cold air supplied to the variable temperature compartment 23.

In response to that the first fan 91 is rotated and an operation of the roll-bond evaporator 50 is stopped to allow the freezing compartment 22 to maintain the first temperature, the freezing compartment 22 may maintain the first temperature and the variable temperature compartment 23 may maintain the second temperature due to the cold air supplied to the inside of the refrigerating compartment 21. That is, in response to that the cold air is not supplied to the variable temperature compartment 23 by stopping the operation of the roll-bond evaporator 50, the variable temperature compartment 23 may maintain the same temperature as the refrigerating compartment 21.

In response to that the amount of cold air guided by the first fan 91 is reduced by reducing the number of revolutions of the first fan 91 and the amount of cold air generated by the roll-bond evaporator 50 is maximized, the freezing compartment 22 may maintain the second temperature, and the variable temperature compartment 23 may maintain the first temperature. Because the amount of cold air supplied to the freezing compartment 22 is reduced due to the reduction of the number of revolutions of the first fan 91, the temperature of the freezing compartment 22 may be increased and be maintained at the second temperature that is the same as the temperature of the refrigerating compartment 21. Accordingly, the freezing compartment 22 may be converted into the refrigerating compartment 21 and used as the refrigerating compartment 21. The variable temperature compartment 23 may maintain the first temperature due to the maximum amount of cold air supplied to the variable temperature compartment 23.

In response to that the amount of cold air guided by the first fan 91 is reduced by reducing the number of revolutions of the first fan 91 and the operation of the roll-bond evaporator 50 is stopped, the freezing compartment 22 may maintain the second temperature, and the variable temperature compartment 23 may maintain the second temperature by the cold air of the inside of the refrigerating compartment 21. Because the amount of cold air supplied to the freezing compartment 22 is reduced due to the reduction of the number of revolutions of the first fan 91, the temperature of the freezing compartment 22 may be increased and maintained at the second temperature that is the same as the temperature of the refrigerating compartment 21. Accordingly, the freezing compartment 22 may be converted into the refrigerating compartment 21 and used as the refrigerating compartment 21. Because the cold air is not supplied to the variable temperature compartment 23 in response to the stop of the operation of the roll-bond evaporator 50, the variable temperature compartment 23 may be cooled by only the cold air of the inside of the refrigerating compartment 21 and thus the variable temperature compartment 23 may maintain the second temperature that is the same as the temperature of the refrigerating compartment 21.

As is apparent from the above description, material cost may be saved because a separate thermal insulation structure is not required.

A space for storing food may be increased in the inside of the variable temperature compartment because a separate thermal insulation structure is not required.

A user can further vary the types of food that is stored in the refrigerator because the freezing compartment is converted into the refrigerating compartment and used as the refrigerating compartment.

It is possible to prevent an increase in power consumption caused by cooling the variable temperature compartment.

Although a few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a body;
a storage compartment provided in the body, having an opening in a front surface thereof, and comprising a freezing compartment and a refrigerating compartment;
a freezing compartment evaporator provided at a rear of the freezing compartment and configured to generate cold air to be supplied to the freezing compartment and the refrigerating compartment;
a fan comprising a first fan configured to guide the cold air generated by the freezing compartment evaporator to the freezing compartment, and a second fan configured to guide the cold air generated by the freezing compartment evaporator to the refrigerating compartment; and
a variable temperature compartment including a roll-bond evaporator disposed inside the refrigerating compartment.

2. The refrigerator of claim 1, further comprising:
a water collecting tray disposed below the variable temperature compartment and provided to collect defrost water that is generated by the roll-bond evaporator.

3. The refrigerator of claim 1, wherein
the variable temperature compartment is provided in a position adjacent to the freezing compartment in the refrigerating compartment.

4. The refrigerator of claim 1, further comprising:
a freezing compartment cold air duct disposed in front of the freezing compartment evaporator and provided to discharge cold air, which is generated by the freezing compartment evaporator, to the freezing compartment,
a refrigerating compartment cold air duct disposed at a rear side of the refrigerating compartment and provided to discharge the cold air, which is guided from the freezing compartment cold air duct, to the refrigerating compartment, and
a connection duct provided to connect the freezing compartment cold air duct to the refrigerating compartment cold air duct.

5. The refrigerator of claim 4, wherein the freezing compartment cold air duct comprises
a first cold air duct disposed in front of the freezing compartment evaporator and provided with a fan mounting portion to which the fan is mounted, and
a second cold air duct disposed in front of the first cold air duct and provided to form a first flow path between the first cold air duct and the second cold air duct, the first flow path provided to guide the cold air, which is generated by the freezing compartment evaporator, to the freezing compartment from the first fan.

6. The refrigerator of claim 5, wherein
the fan mounting portion comprises a first fan mounting portion to which the first fan is mounted, and a second fan mounting portion to which the second fan is mounted.

7. The refrigerator of claim 6, wherein the first cold air duct comprises
a refrigerating compartment guide duct provided to form a portion of a second flow path provided to guide the cold air, which is generated by the freezing compartment evaporator, to the refrigerating compartment from the second fan,
a first guide portion provided to form a remaining portion of the second flow path by being connected to the refrigerating compartment guide duct, and
a cold air discharge portion provided to connect the first guide portion to the connection duct to guide the cold air of the second flow path to the connection duct.

8. The refrigerator of claim 7, wherein the second cold air duct comprises
a plurality of freezing compartment discharge holes provided to discharge the cold air of the first flow path to the freezing compartment, and
a second guide portion provided to form a remaining portion of the second flow path together with the first guide portion.

9. The refrigerator of claim 1, wherein
a temperature of the variable temperature compartment is adjusted according to an amount of cold air supplied from the roll-bond evaporator, and
a temperature of the freezing compartment is adjusted to be maintained at the same temperature as a temperature of the refrigerating compartment by adjusting a speed of the first fan to reduce an amount of cold air supplied to the freezing compartment.

10. The refrigerator of claim 9, wherein
the temperature of the variable temperature compartment is adjusted to be maintained at the same temperature as a temperature of the freezing compartment or the refrigerating compartment according to an amount of cold air supplied from the roll-bond evaporator.

11. The refrigerator of claim 10, wherein
the temperature of the freezing compartment is a first temperature and the temperature of the refrigerating compartment is a second temperature, and
the refrigerating compartment maintains the second temperature by controlling an amount of cold air, which is generated by the freezing compartment evaporator and then guided by the second fan, to be constant.

12. The refrigerator of claim 11, wherein
the first fan is rotated and an amount of cold air generated by the roll-bond evaporator is maximized to maintain the first temperature in the freezing compartment, and
the variable temperature compartment maintains the first temperature.

13. The refrigerator of claim 11, wherein
the first fan is rotated and an operation of the roll-bond evaporator is stopped to maintain the first temperature in the freezing compartment, and
the variable temperature compartment maintains the second temperature by the cold air inside of the refrigerating compartment.

14. The refrigerator of claim 11, wherein
the amount of cold air guided by the first fan is reduced by reducing the speed of the first fan, and the amount of cold air generated by the roll-bond evaporator is maximized, so that the freezing compartment maintains the second temperature, and the variable temperature compartment maintains the first temperature.

15. The refrigerator of claim 11, wherein
the amount of cold air guided by the first fan is reduced by reducing the speed of the first fan, and the operation of the roll-bond evaporator is stopped, so that the freezing compartment maintains the second temperature, and the variable temperature compartment maintains the second temperature by the cold air inside of the refrigerating compartment.

16. A refrigerator comprising:
a body;
a storage compartment provided in the body, having an opening in a front surface thereof, and comprising a freezing compartment and a refrigerating compartment;
a freezing compartment evaporator configured to generate cold air to be supplied to the freezing compartment and the refrigerating compartment;
a fan comprising a first fan configured to guide the cold air generated by the freezing compartment evaporator to the freezing compartment, and a second fan configured to guide the cold air generated by the freezing compartment evaporator to the refrigerating compartment; and
a variable temperature compartment including a roll-bond evaporator disposed inside the refrigerating compartment and configured to adjust a temperature of the variable temperature compartment according to an amount of cold air supplied from the roll-bond evaporator,
wherein a temperature of the freezing compartment is adjusted to be maintained at the same temperature as a temperature of the refrigerating compartment by reducing a speed of the first fan to reduce an amount of cold air discharged by the first fan.

17. The refrigerator of claim 16, wherein
an amount of cold air supplied from the roll-bond evaporator is maximized in a state in which the temperature of the refrigerating compartment is kept constant, so that the variable temperature compartment maintains a same temperature as the freezing compartment.

18. The refrigerator of claim 16, wherein
an operation of the roll-bond evaporator is stopped in a state in which the temperature of the refrigerating compartment is kept constant, and
the variable temperature compartment maintains a same temperature as the refrigerating compartment by an internal temperature of the refrigerating compartment.

19. The refrigerator of claim 16, wherein
the variable temperature compartment is affected by an internal temperature of the refrigerating compartment and the variable temperature compartment is separately cooled by the roll-bond evaporator so that the variable temperature compartment is adjusted to maintain a temperature less than or equal to a temperature of the refrigerating compartment.

20. The refrigerator of claim 19, wherein,
the variable temperature compartment is provided in a position adjacent to the freezing compartment in the refrigerating compartment, and a water collecting tray is disposed below the variable temperature compartment and provided to collect defrost water that is generated by the roll-bond evaporator.
